(19) United States
(12) Patent Application Publication
(10) Pub. No.: US 2023/0103703 A1
(43) Pub. Date: Apr. 6, 2023

(54) LIQUID CONVEYING SYSTEM, AND LINING BAG AND MANUFACTURING METHOD THEREFOR

(71) Applicant: HOREN CORTP CO., LTD., Shanghai (CN)

(72) Inventor: Zhengwei FANG, Shanghai (CN)

(21) Appl. No.: 17/907,068

(22) PCT Filed: Mar. 23, 2021
(86) PCT No.: PCT/CN2021/082330

§ 371 Date: Sep. 22, 2022

(30) Foreign Application Priority Data
Mar. 23, 2020 (CN) 202010209030.9

(51) Int. Cl. B65D 77/06; B65D 88/54; B65D 88/52; B65B 69/00; B65D 90/02; B65D 90/08

(52) U.S. Cl. CPC B65D 77/06; B65B 69/0075; B65D 88/52; B65D 88/54; B65D 90/08; B65D 90/021

(57) ABSTRACT

The invention discloses a liquid conveying system, a liner bag and a manufacturing method. The liner bag comprises a liner bag body and a discharge port, the liner bag body is formed by sealing and welding a front panel and a rear panel along the periphery, and the discharging port is sealedly connected with the liner bag body. The liner bag body is substantially rectangular, and the liner bag body has two pairs of opposite side edges, and corresponding adjacent side edges of the two pairs of opposite side edges are connected by one or more transition edges The liner bag of the invention is simple to manufacture and does not form a damming lake during the liquid discharge process, which is especially beneficial for the discharge of viscous liquid, and less liquid remains after the discharge is completed.

### CROSS-REFERENCE TO RELATED APPLICATIONS

This application claims the priority of the Chinese application No. 2020102090309, titled “Liquid Conveying System and Liner Bag and Manufacturing Method thereof” filed on March 23^{rd}, 2020, the contents of which are incorporated by reference herein.

### TECHNICAL FIELD

The present invention relates to containers, and in particular to liner bags for containing liquids.

### TECHNICAL BACKGROUND

In order to store, transport, fill and discharge liquid, there are many liquid storage and transportation devices on the market, including Intermediate Bulk Containers (IBC) with liner bags for storing and transporting solutions. The liner bags used for IBC on the market are generally three-dimensional liner bags with six sides and pillow-type liner bags with two sides. The production of three-dimensional liner bags is very difficult, because each side of the three-dimensional liner bags has to be welded, so the production efficiency is very low and the cost is high. Pillow-type liner bags are currently used more and more in the market because of their convenience and low processing costs.

The Chinese patent No. CN201320108508 discloses a sealed liquid bag, the main part of which is a sealed soft container made of PVC plastic-coated cloth by thermal-fusion welding or high-frequency welding; both ends of the sealed soft container are respectively provided with a filling valve and a discharging valve. The liquid liner bag has a better effect in general high flow rate and liquid with great fluidity. However, in the discharge of viscous liquid, the discharging rate is slow and the efficiency is low; when discharging is completed, a certain amount of liquid remains in the liner bag, resulting in a waste of costs. Generally, at the end of the discharge, external tools such as screw extrusion will be used to wrap the liner bag to squeeze out the remaining liquid.

### SUMMARY

An object of the present invention is to provide a liner bag which is convenient for welding and facilitates the discharge of liquids contained therein, especially viscous liquids.

In order to achieve the above object, according to an aspect of the present invention, a liner bag is provided, the liner bag comprises a liner bag body and a discharging port, the liner bag body is formed by sealing and welding a front panel and a rear panel along the periphery, and the discharging port is sealedly connected to the liner bag body, wherein the liner bag body is substantially rectangular, and the liner bag body has two pairs of opposite side edges, and corresponding adjacent side edges of the two pairs of opposite side edges are connected by one or more transition edges.

In an embodiment, the front panel and the rear panel are substantially rectangular flexible panels.

In an embodiment, a vertical distance between a vertex of each side edge of the two pairs of opposite side edges and the adjacent side edge is equal to 1/20~⅒ of a total length of the side edge.

In an embodiment, angles formed between adjacent edges of all corners of the liner bag body are obtuse angles.

In an embodiment, edges forming each corner of the liner bag body are straight or arc edges.

In an embodiment, the liner bag has an unfolded state and a folded state, in the folded state, a first pair of opposing side portions of the liner bag body are folded upwardly so that a portion of the liner bag body containing the discharging port faces upwardly, and a second pair of opposite side portions of the liner bag body are folded upwardly towards the discharging port, so that the edges of the second pair of opposite sides are adjacent to the discharge port.

In an embodiment, the liner bag further has a filling port, and the filling port and the discharging port are respectively located on the front panel and the rear panel.

In an embodiment, the discharging port is closer to the edges of the liner bag body than the filling port.

In an embodiment, the filling port is located in the middle of the front panel, the discharging port is located in the rear panel, and a distance between an edge of the discharging port and a nearest edge of the liner bag body is smaller than one quarter of the length of the liner bag.

In an embodiment, the liner bag has an unfolded state and a folded state, in the folded state, a first pair of opposing side portions of the liner bag body are folded upwardly, so that the discharging port and the filling port are in the same plane, and a second pair of opposite side portions of the liner bag body are folded upwardly toward the filling port, so that edges of the second pair of side portions are adjacent to the filling port and the discharging port.

In an embodiment, the volume of the liner bag is between 200 L and 1250 L, preferably 250 L, 1000 L or 1200 L.

According to another aspect of the present invention, there is provided a method of manufacturing a liner bag, the liner bag comprising a liner bag body and a discharging port, the liner bag body comprising a substantially rectangular front panel and a rear panel, wherein the manufacturing method includes the following steps:
sealing and welding the front panel and the rear panel along the periphery, and sealedly connecting the discharging port with the liner bag body, wherein the liner bag body has two pairs of opposite side edges, and the corresponding adjacent side edges of the two pairs of opposite side edges are connected by one or more transition edges;
folding the first pair of opposing side portions of the liner bag body upwardly so that a portion of the liner bag body containing the discharging port faces upwardly, and the second pair of opposing side portions of the liner bag body is folded upwardly towards the discharging port so that the edges of the second pair of opposing side portions are adjacent to the discharging port.

According to yet another aspect of the present invention, there is provided a liquid conveying system comprising an IBC, a liner bag, and a squeezer, wherein the IBC comprises a base and side walls mounted on the base, the base is provided with a discharging channel, the liner bag is placed in the IBC and includes a liner bag body and a discharging port, and the squeezer has a pair of rollers, wherein:
the liner bag includes a liner bag body and a discharging port, the liner bag body is formed by sealing and welding a front panel and a rear panel along the periphery, and the discharging port is sealedly connected with the liner bag body, the liner bag body is substantially rectangular, and four corners of the liner bag body are chamfered;
the discharging port of the liner bag is mounted in the discharging channel; and
the squeezer is arranged to be placed over the liner bag with the pair of rollers clamping a top end of the liner bag when the liquid within the liner bag is discharging.

The liner bag of the invention is convenient to manufacture and does not form a damming lake during the liquid discharging process, which is especially beneficial for the discharging of viscous liquid, and less liquid remains after the discharging is completed.

### DESCRIPTION OF DRAWINGS

FIG. 1 is a schematic view showing the structure of a liner bag according to a first embodiment of the present invention.

FIG. 2 is a schematic view showing the structure of a liner bag according to a second embodiment of the present invention.

FIG. 3 is a schematic view showing the structure of a liner bag according to a third embodiment of the present invention.

FIGS. 4 to 7 are schematic views showing a folding process of the liner bag shown in FIG. 1.

FIGS. 8 to 10 are diagrams illustrating a process of filling a liquid in a liner bag according to an embodiment of the present invention.

FIGS. 11 to 13 are diagrams illustrating a process of filling a liquid in a liner bag according to another embodiment of the present invention.

FIGS. 14 to 17 are schematic diagrams illustrating a process of discharging liquid by a liquid conveying system according to an embodiment of the present invention.

### EMBODIMENTS

The embodiments of this invention will be described in detail with reference to the accompanying drawings, so that the purposes, the characteristics and the advantages of the invention can be more clearly understood. It should be understood that the embodiments shown in the figures are not intended to limit the scope of this invention, but illustrate the essential spirit of the technical solution of this invention.

In the following description, certain specific details are set forth for purposes of illustrating the various disclosed embodiments to provide a thorough understanding of the various disclosed embodiments. However, those skilled in this art will recognize that embodiments may be practiced without one or more of these specific details. In other instances, well-known devices, structures, and techniques associated with the present application may not be shown or described in detail to avoid unnecessarily obscuring the description of the embodiments.

Unless otherwise desired by context, throughout the specification and claims, the terms “comprising” and variations thereof, such as “containing” and “having”, are to be construed as non-exclusive, i.e., to be construed as “comprising, but not limited to”

Throughout the specification “one embodiment” or “one embodiment” means that a particular feature, structure, or characteristic described in connection with the embodiment is included in at least one embodiment. Therefore, the presence of “in one embodiment” or “in one embodiment” at various locations throughout the specification need not all refer to the same embodiment. Additionally, particular features, structures, or features may be combined in any manner in one or more embodiments.

The singular forms “a” and “said” as used in the specification and appended claims include plural references unless the context clearly dictates otherwise. The term “or” be used in its usual sense including “and/or” unless the context clearly dictates otherwise.

In the following description, for clarity of illustration of the structure and mode of operation of the present invention, various directional terms will be used to describe the present invention, but words such as “front”, “rear”, “left”, “right”, “outer”, “inner”, “outward”, “inward”, “upper”, “lower”, and the like, should be understood as convenient terms and should not be construed as limiting terms.

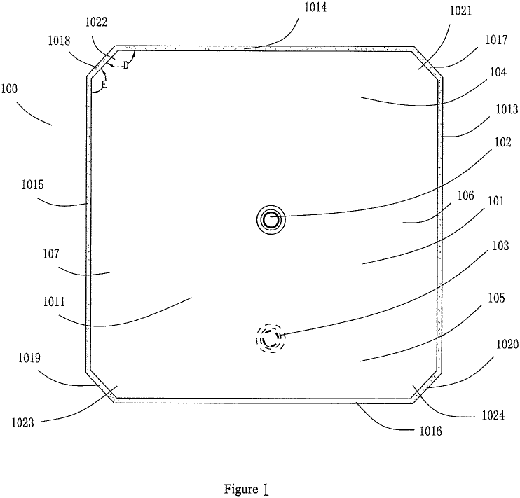

FIG. 1 is a schematic view showing the structure of a liner bag 100 according to a first embodiment of the present invention. As shown in FIG. 1, the liner bag 100 includes a liner bag body 101, a filling port 102 and a discharging port 103. The liner bag body 101 is formed by sealing and welding a front panel 1011 and a rear panel 1012 together along the periphery. A main welding line 100a of the liner bag 100 is formed at a peripheral edge of the liner bag body 101. Preferably, the front panel 1011 and the rear panel 1012 are substantially rectangular flexible panels. The front and rear panels are usually made of plastic. The filling port 102 and the discharging port 103 are sealedly connected with the liner bag body 101. Specifically, the filling port 102 and the discharging port 103 are welded on the front panel 1011 and the rear panel 1012 respectively. The discharging port 103 is closer to an edge of the liner bag body 101 than the filling port 102. Preferably, the filling port 102 is located on the middle of the front panel, the discharging port is located on the rear panel, and the distance between the edge of the discharging port and the nearest edge of the liner bag body 101 is less than one quarter of the length of the liner bag.

The liner bag body 101 is rectangular as a whole, and its shape is basically formed by chamfering four corners of a rectangle. During production, the four corners of the front panel and the rear panel can be chamfered firstly, and then sealed and welded along the periphery, or the rectangular front panel and the rear panel can be sealed and welded along the periphery firstly, and then the four corners are chamfered and the chamfered parts are welded together. The filling port and the discharging port can be hermetically connected to the front and rear panels, respectively, before or after the front and rear panels are welded together.

Specifically, the liner bag body 101 has two pairs of opposite side edges 1013, 1014, 1015, and 1016. Corresponding adjacent side edges of the two pairs of opposite side edges are connected by one transition edge 1017, 1018, 1019, and 1020 respectively. The transition edge can be a straight edge or an arc edge. FIG. 1 shows a straight edge. The angles A, B, C, D, and E formed between each side edge and the transition edge are obtuse angles. The liner bag body 101 has four corners 1021, 1022, 1023 and 1024. When the transition edge is a straight edge, the angles formed between the adjacent edges of all corners of the liner bag body 101 are obtuse angles. The vertical distance between the vertex of each side edge in the two pairs of opposite side edges and the adjacent side edge is equal to 1/20~⅒ of a total length of the side edge, preferably 1/15~⅒ of the total length.

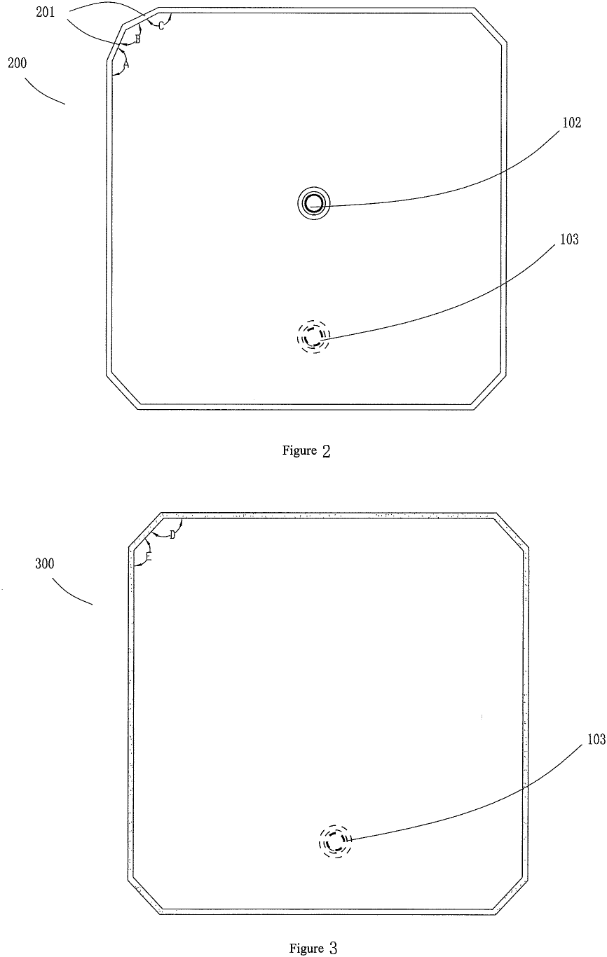

FIG. 2 is a schematic view showing the structure of a liner bag 200 according to a second embodiment of the present invention. The difference between the liner bag 200 of the embodiment shown in FIG. 2 and the liner bag 100 shown in FIG. 1 is that at least one corner of the liner bag 200 has a plurality of transition edges 201. FIG. 2 shows one of the corners with two transition edges. It should be understood that each of two, three or four corners may have more than two transition edges. The transition edges can be straight lines or arc lines. The rest of the liner bag 100 and 200 are the same and will not be described in detail again here.

FIG. 3 is a schematic view showing the structure of a liner bag 300 according to a third embodiment of the present invention. The difference between the liner bag 300 of the embodiment shown in FIG. 3 and the liner bag shown in FIGS. 1 and 2 is that the liner bag 300 is not provided with a separate filling port, but integrates the filling port and the discharging port together, that is, the discharging port 301 is also used as a filling port. The structure and manufacturing method of the liner bag may be the same as the liner bag 100 shown in FIG. 1 or the liner bag 200 shown in FIG. 2 , and will not be described in detail again here.

Herein, the specification (i.e. volume) of the liner bag is between 200 L and 1250 L, preferably 250 L, 1000 L or 1200 L, and the dimensions of the front panel and the rear panel corresponding to the three specifications of the liner bag are respectively about 0.95 m×1.55 m, 2.1 m×2.25 m and 2.1 m×2.45 m.

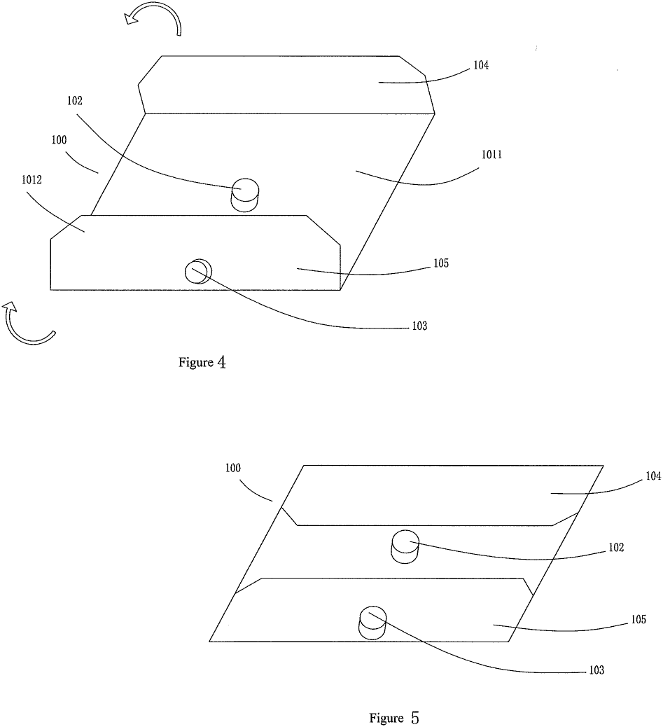

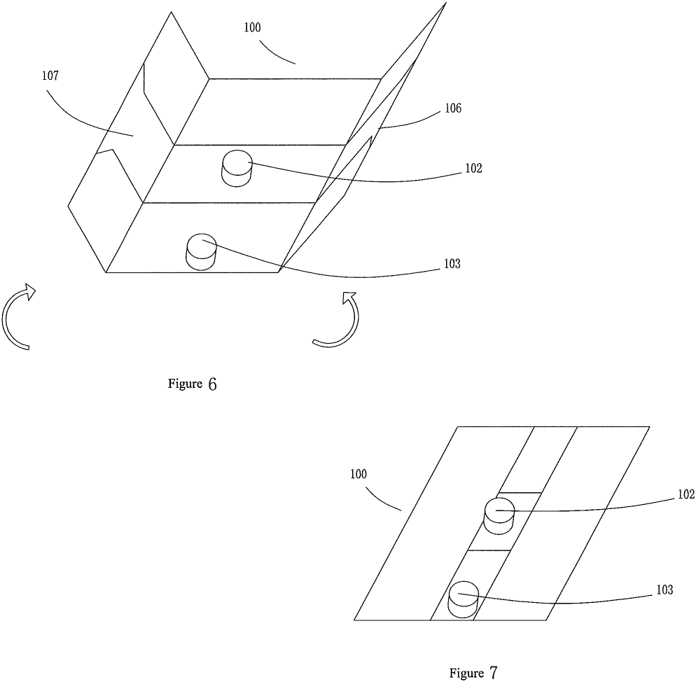

FIGS. 4 to 7 are schematic views showing a folding process of the liner bag 100 shown in FIG. 1. The liner bag of the present application has an unfolded state and a folded state. In the folded state, the first pair of opposing side portions 104 and 105 of the liner bag body 101 are folded upwardly, and a portion of the liner bag body containing the discharging port 103 faces upwardly, so that the discharging port and the filling port are in the same plane, and the second pair of opposing side portions 106 and 107 of the liner bag body are folded upwardly toward the filling port, so that the edges of the second opposing side portions are adjacent to the filling and discharge ports. As an example, during the folding process of the liner bag 100, the first pair of opposite side edges of the liner bag body are folded toward the filling port firstly, so that the discharging port and the filling port are in the same plane, and the second pair of opposing side edges of the liner bag body is folded towards the filling port, so that the edges of the second pair of opposing side edges are adjacent to the filling port and the discharge port. Thereby the folding is completed. The folding process of the liner bags 200 and 300 shown in FIG. 2 and FIG. 3 is the same as the folding process of the liner bag 100 shown in FIG. 1 , and will not be described in detail again herein.

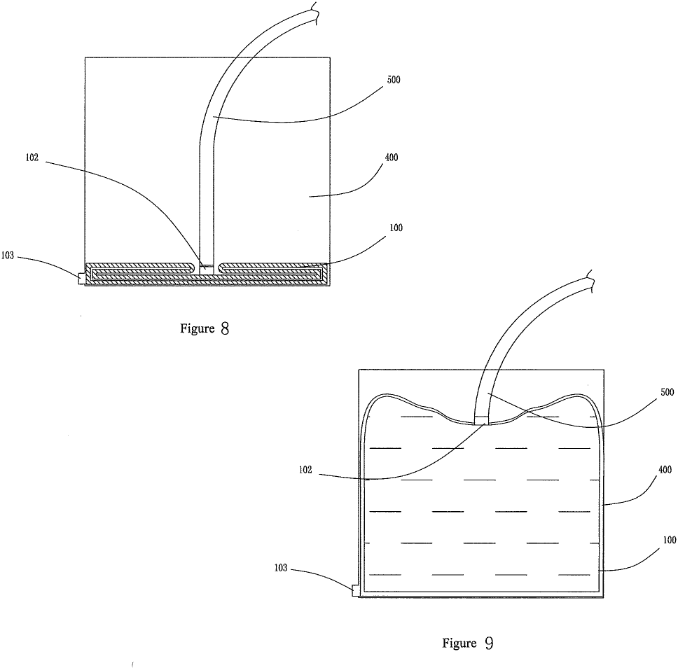

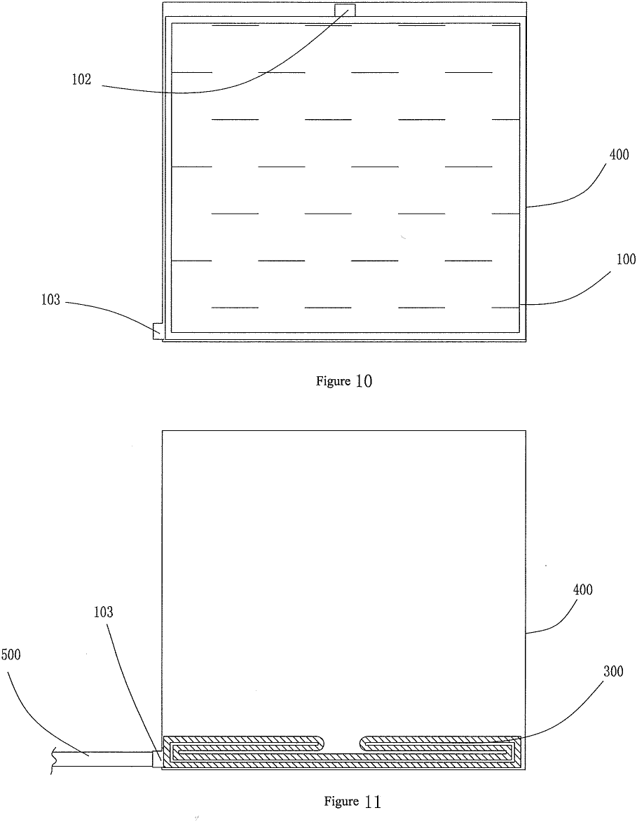

FIGS. 8 to 10 are diagrams illustrating a process of filling liquid of the liner bag 100 according to an embodiment of the present invention. As shown in the figures, during the filling process, the liner bag 100 is firstly placed flat on the bottom of the intermediate bulk container (IBC) 400 with the filling port 102 facing upwardly, and the discharging port 103 is installed in the discharging channel of the IBC. Next, the filling port 102 is connected to a pipe 500 , and then the liquid is filled into the liner bag 100 via the pipe 500.

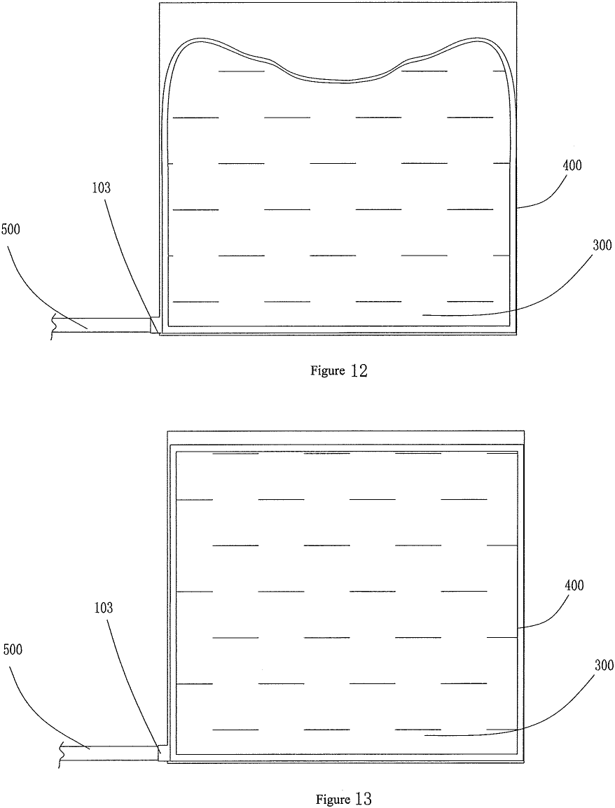

FIGS. 11 to 13 are diagrams illustrating a process of filling a liquid in a liner bag 300 according to another embodiment of the present invention. As shown in the figures, during the filling process, the liner bag 300 is firstly placed flat on the bottom of the intermediate bulk container (IBC) 400, and the discharging port 103 is installed in the discharging channel of the IBC. Next, the discharging port 102 is connected to a pipe 500 , and then the liquid is filled into the liner bag 100 via the pipe 500.

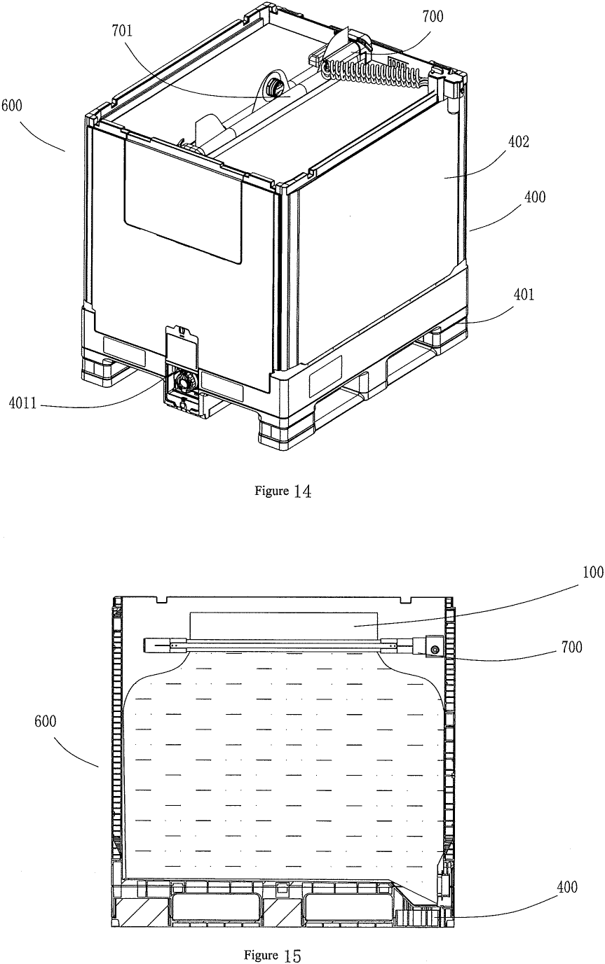

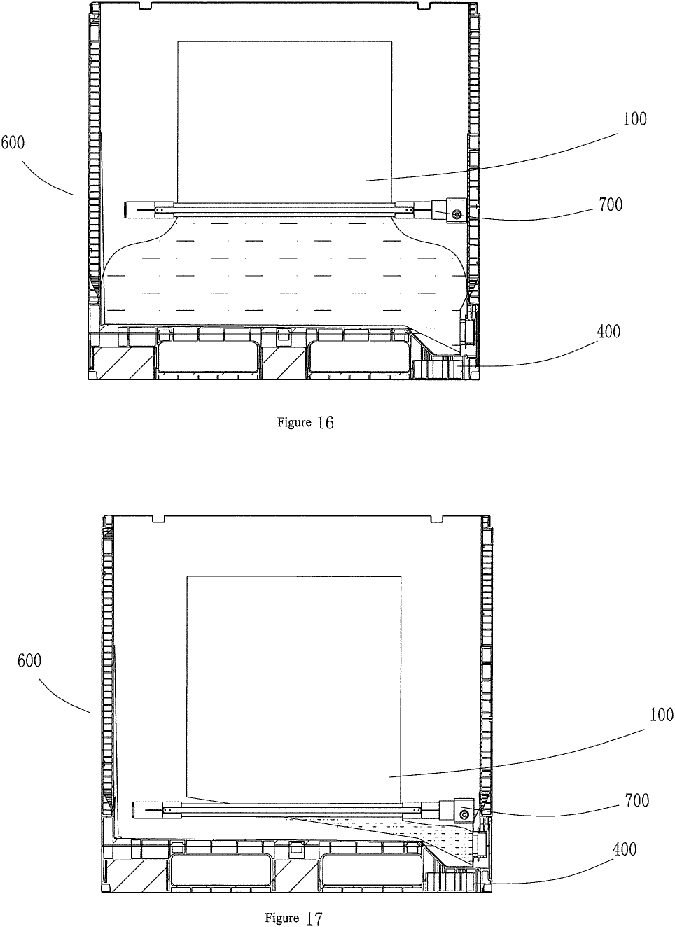

FIGS. 14 to 17 are schematic diagrams illustrating a process of discharging liquid by a liquid conveying system 600 according to an embodiment of the present invention. As shown in FIGS. 14-17, the liquid conveying system 600 includes an IBC 400, a liner bag, and a squeezer 700, wherein the IBC 400 includes a base 401 and side walls 402 mounted on the base. A discharge channel 4011 is provided in the base 401. The liner bag is placed in the IBC and the discharging port of the liner bag is installed in the discharging channel. The squeezer 700 has a pair of rollers 701. The squeezer may use the squeezer disclosed in the Chinese Invention Patent Application No. 201710656555.5, the full text of which is incorporated herein by reference. The squeezer may also use the squeezer known in the art or to be developed.

During discharging, the squeezer is placed over the liner bag and a pair of rollers clamps the top end of the liner bag. A valve installed outside the IBC discharging channel is then opened and the squeezer is activated. During the discharging process, the pair of rollers of the squeezer rotates to squeeze the liner bag, thereby squeezing the liquid down and reducing the liquid remained in the liner bag body. During the discharging process, the squeezer will automatically descend with the reduction of the liquid in the liner bag.

The liner bag of the present invention improved all corners, and each corner is no longer a conventional right angle, thereby solving the problem of the dammed lake of the liner bag, and there is no dead corner for liquid retention, so that the residual amount after discharging is small. In addition, the structure is simple, the folding and filling operations are simple, and the cost is saved, and it is especially suitable for accommodating and transporting viscous liquids.

The preferred embodiments of the present invention have been described in detail, but it should be understood that, after reading the above teachings of the present invention, various modifications or modification of the present invention can be made by those skilled in the art..These equivalent forms are also within the scope defined by the claims appended hereto.

1. A liner bag, the liner bag comprises a liner bag body, a filling port and a discharging port, the liner bag body is formed by sealing and welding a front panel and a rear panel along the periphery, and the filling port and the discharging port are located at the front panel and the rear panel respectively and sealedly connected to the liner bag body, wherein the liner bag body is substantially rectangular, and the liner bag body has two pairs of opposite side edges, corresponding adjacent side edges of the two pairs of opposite side edges are connected b one or more transition edges; and the filling port is closer to the edge of the liner bag body than the discharging port.

2. The liner bag according to claim 1, wherein the front panel and the rear panel are substantially rectangular flexible panels.

3. The liner bag according to claim 1, wherein a vertical distance between a vertex of each side edge of the two pairs of opposite side edges and the adjacent side edge is equal to 1/20~⅒ of a total length of the side edge.

4. The liner bag according to claim 1, wherein angles formed between adjacent edges of all corners of the liner bag body are obtuse angles.

5. The liner bag according to claim 1, wherein edges forming each corner of the liner bag body are straight or arc edges.

6. The liner bag according to claim 1, wherein, the liner bag has an unfolded state and a folded state, in folded state, a first pair of opposing side portions of the liner bag body are folded upwardly, so that a portion of the liner bag body containing the discharging port faces upwardly, and a second pair of opposite side portions of the liner bag body are folded upwardly towards the discharging port, so that edges of the second pair of opposite side portions are adjacent to the discharge port.

7. The liner bag according to claim 1, wherein, the filling port is located in the middle of the front panel, the discharging port is located in the rear panel, and a distance between an edge of the discharging port and a nearest edge of the liner bag body is smaller than one quarter of the length of the liner bag.

8. The liner bag of claim 1, wherein the liner bag has an unfolded state and a folded state, in the folded state, a first pair of opposing side portions of the liner bag body are folded upwardly, so that the discharging port and the filling port are in the same plane, and a second pair of opposite side portions of the liner bag body are folded upwardly toward the filling port, so that edges of the second pair of side portions are adjacent to the filling port and the discharging port.

9. The liner bag according to claim 1, wherein the volume of the liner bag is between 200 L and 1250 L.

10. The liner bag according to claim 1, wherein liner bag has a volume of 250 L, 1000 L or 1200 L.

11. A method of manufacturing a liner bag, the liner bag comprising a liner bag body, a filling port, and a discharging port, the liner bag body comprising a substantially rectangular front panel and a rear panel, the filling port and the discharging port are located at the front panel and the rear panel respectively wherein the manufacturing method includes the following steps:
sealing and welding the front panel and the rear panel along the periphery, and sealedly connecting the discharging port and the filling port with the liner bag body, such that the filling port is closer to the edge of the liner bag body than the discharging port, wherein the linear bag body has two pairs of opposite side edges, corresponding adjacent side edges of the two pairs of opposite side edges are connected by one or more transition edges;
folding a first pair of opposing side portions of the liner bag body upwardly, so that a portion of the liner bag body containing the discharging port faces upwardly, and a second pair of opposing side portions of the liner bag body is folded upwardly towards the discharging port, so that edges of the second pair of opposing side portions are adjacent to the discharging port.

12. A liquid conveying system comprising an IBC, a liner bag, and a squeezer, wherein the IBC comprises a base and side walls mounted on the base, the base is provided with a discharging channel, the liner bag is placed in the IBC and includes a liner bag body, a filling port and a discharging port, and the squeezer has a pair of rollers, wherein:
the liner bag body is formed by sealing and welding a front panel and a rear panel along the periphery, and the filling port and the discharging port are located at the front panel and the rear panel respectively and sealedly connected with the liner bag body, and the filling port is closer to the edge of the liner bag body than the discharging port, the liner bag body is substantially rectangular, and four corners of the liner bag body are chamfered;
the discharging port of the liner bag is mounted in the discharging channel; and
the squeezer is arranged to be placed over the liner bag with the pair of rollers clamping a top end of the liner bag when the liquid within the liner bag is discharging.
